(19) United States
(12) Patent Application Publication
(10) Pub. No.: US 2017/0239555 A1
(43) Pub. Date: Aug. 24, 2017

(54) Light Up

(71) Applicant: Nery Alvarado, Redwood City, CA (US)

(72) Inventor: Nery Alvarado, Redwood City, CA (US)

(21) Appl. No.: 15/047,920

(22) Filed: Feb. 19, 2016

(51) Int. Cl. A63C 17/26; F21V 15/01; F21L 4/02

(52) U.S. Cl. CPC A63C 17/26; F21L 4/02; F21V 15/01; F21Y 2115/10

(57) ABSTRACT

A removable lighting system for skates or skateboards by mounting a lighting assembly underside of the skateboard and providing a light in the night to the user. The lighting system, including: a riding platform having a top riding surface and a bottom surface a front lighting source; a back lighting source and at least one power source.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) FIELD OF THE INVENTION

The present invention relates to lighting systems for use with roller skates and/or skateboards. In particular, it relates to a removable lighting system that attaches directly to skateboards and ski equipment for the purpose of providing visibility and safety.

(2) BACKGROUND OF THE INVENTION

Currently, a wide variety of wheeled amusement devices, such as skates and skateboards are used by young and old alike. In particular, roller skates have found wide use both indoor and outdoors in roller skating rings and for general use on streets and sidewalks.

Use of roller skates has led to some difficulty when used in poorly lit places such as darkened roller rinks or when used outdoors in the night. In areas such as indoor roller rinks the use of low level lighting generally does not lead to safety problems, but it can detract from the aesthetics of the activity. On the other hand, in outdoor use the absence of adequate lighting quite often does result in the exposure of the skater to danger from automobiles. Attempts have been made to provide some lighting capability to footwear and other devices used by pedestrians such as athletic shoes, roller skates, or skateboards.

In the case of athletic shoes, one of the methods used to enhance the visibility of the wearer has been to place lights in the heel and around the periphery of the athletic shoes. The lights used by this type of device are normally triggered by a switch in the heel of the shoe that automatically activates a light each time the user takes a step. The lights are ordinarily LEDs and are powered by a battery contained with the shoe. This type of lighting system has both ornamental value, and in addition, provides some safety value since the lights can improve the visibility of a pedestrian at night so long as the pedestrian is moving. Of course, if the pedestrian is standing still, the lights are normally off. A disadvantage of the device is that the light assembly is visible even when not in use.

Another type of device which has used lighting systems is the skateboard. It is known, for example, to put head light and tail light arrangements on skateboards both for forward illumination purposes and rear lighting. These devices can be configured as small flash light assemblies which mount on the underside of the skateboard. Likewise, rail bars are known which arrange LEDs around the periphery of the skateboard. Typically, these types of systems have switched and battery assemblies mounted on the underside of the skateboard.

Another device commonly used is roller skates. Attempts to provide lighting systems for this type of device have usually involved the attachment of a flashlight device to provide a headlight, or tail light function to roller skates. This type of lighting system typically attaches to the tow brake on the front of a roller skate or the underside of the skate at the rear. There have been known tow brakes that have led lighting arrangements built in to the tow brake on the front of the skate.

Another approach used in conjunction with roller skates has been to provide lighting in or on the wheels themselves. One such method includes making the light an integral part of the wheel. A second approach is to add on a device to the side of the wheel. This allows light to be provided to pre-existing skates. However, in both of these configurations as well as the configuration that uses the tow brake, the lighting assemblies detract from the appearance of the roller skates and may also interfere with the use of the roller skates due to the size of the lighting assemblies. These configurations are suitable for the older type of roller skates whose wheels are configured in a square pattern with wheels in each of four corners. These wheels tend to be large and wide.

Other lighting methods and devices similar in structure to a flashlight which attaches to a skateboard are known. For example, U.S. Pat. No. 5,067,058 to Standley Michael P; U.S. Pat No. 5,119,277 to David R. Ekedal; U.S. Pat. No. 7,048,284 to Illuminated Sports; U.S. Pat. No. 6,802,636 to Richard B Bailey, Jr.; U.S. Pat. No. 8,038,313 to Photon Light Boards, Inc.; U.S. Pat. No. 8,083,238 to Seth Borges; U.S. Pat. No. 8,506,140 to Roland Edmisten and U.S. Pat. No. 5,513,080 to Magle; Thomas 0., Earney; Richard.

The prior art has failed to provide a single system which is capable of being inconspicuous when not in use, which provides for convenient change of light by the user, which provides safety by lighting, which has the ability to relocate the lighting on the skate or on a skateboard, and which has the inability to provide very low power systems which can operate for extended periods on a lightweight battery.

### SUMMARY OF THE INVENTION

The present invention overcomes the foregoing problems and disadvantages of the prior art with an improved lighting system that attaches directly to skateboards and ski equipment for the purpose of providing visibility and safety.

A primary object of the present invention is to provide a removable lighting system that attaches directly to skateboards and ski equipment which overcomes the shortcomings of the prior art.

Another object of the present invention is to provide a removable lighting system for skateboard having a plurality of LED's attached to the bottom of the board.

Another object of the present invention is to provide a removable lighting system for skateboard which provide safety to the user from accidents.

In light of the above, it would be advantageous to provide a removable lighting system for skateboard with a unique, customizable appearance. It would also be advantageous to provide individual skateboarders with the ability to visibly stand out in the night to the skaters.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective front view of the lighting system for skateboard of the present invention showing a light emitting device pattern, and shows the general illumination pattern extending from the board; and

FIG. 2 is a perspective back view of the removable lighting system for skateboard of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

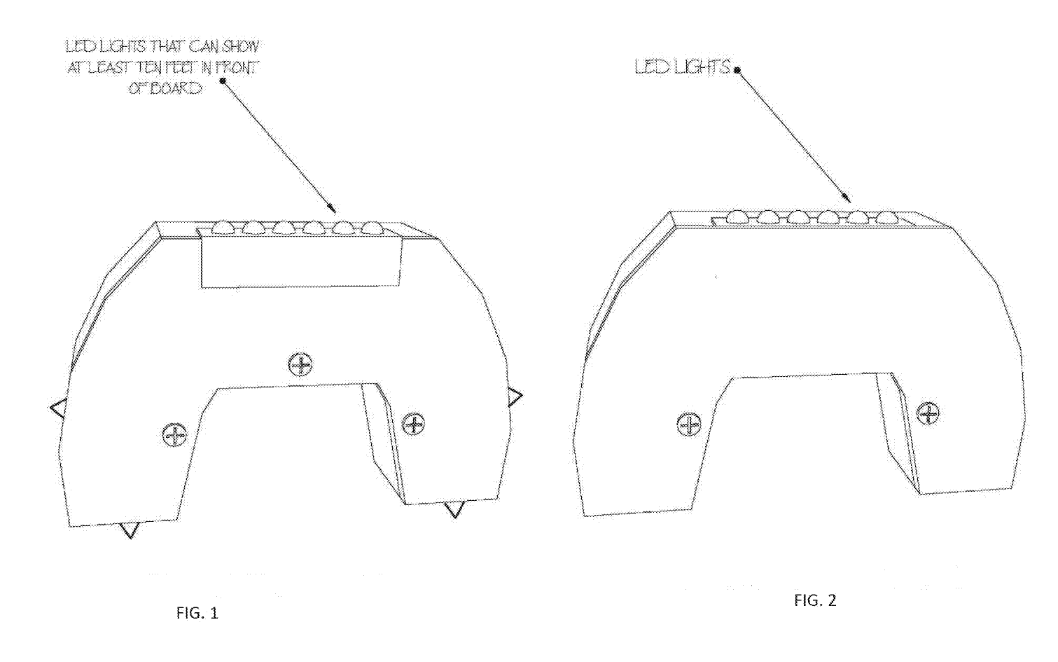

FIGS. 1 and 2 is a perspective view of one embodiment of a lighting system for skateboard including, a riding platform having a top riding surface and a bottom surface, a lighting system configured at the bottom to produce light, mounted front and back of the board. In the embodiment of FIG. 1 and 2, the light system is a visible light source that may include, for example, multiple light-emitting diodes (LEDs) connected one after another to form a string. The multiple LEDs may be the same or of different colors. Further, the LEDs may be turned on and off to flash in certain patterns, or sequentially, such that it appears that the light emitted by the LEDs is moving around the board.

The present lighting system for skateboard is preferably constructed from a lightweight material such as plastic, etc. In the present system, front light should show at least ten feet in front of the board. A flexible or semi-flexible material is preferred in order to mitigate damage from impacts which can happen during normal use of skateboard. The preferred embodiment envisions a lighting system for skateboard which is 3⅞ inches wide and 2½ inches long including the various attachments. The Attachment for like devices are well known in the art and can be accomplished by any suitable method such as a snap-on connectors, screws, etc. Providing for easy removal and replacement of the light allows users to conveniently change the appearance of the skateboard and also prevent it from damage.

In another embodiment the lighting system further includes an electrical power source. In general, the power source produces electrical power and provides the electrical power to the driver circuit. The power source may be or include, for example, a battery.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

We claim:

1. A removable lighting system for skateboard comprises, in combination:
a riding platform having a top riding surface and a bottom surface
a front lighting source;
a back lighting source and
at least one power source.

2. The removable lighting system of claim 1, wherein said light source, includes multiple light-emitting diodes (LEDs).

3. The removable lighting system of claim 1, wherein said power source includes a battery.

4. The removable lighting system of claim 1, wherein said system providing proper visibility at night to the skaters.

5. The removable lighting system of claim 1, wherein said system providing effective safety measures in traffic.
